(19) United States
(12) Patent Application Publication
(10) Pub. No.: US 2026/0348993 A1
(43) Pub. Date: Nov. 5, 2026

(54) Vision System for Quality Control in a Library Preparation System

(71) Applicant: ILLUMINA, INC., San Diego, CA (US)

(72) Inventors: Bryan Crane, San Diego, CA (US); Peter Thomas, Poway, CA (US); Emily Parker, San Diego, CA (US); James Osmus, San Diego, CA (US); Morgan Proffitt, San Diego, CA (US); Sohela De Rozieres, San Diego, CA (US)

(21) Appl. No.: 19/488,406

(22) PCT Filed: Dec. 18, 2024
(86) PCT No.: PCT/US2024/060653

§ 371 Date: Nov. 26, 2025

Related U.S. Application Data
(60) Provisional application No. 63/613,697, filed on Dec. 21, 2023.

(51) Int. Cl. G01N 35/00; G01N 35/10; G06V 20/52

(52) U.S. Cl. CPC G01N 35/00623; G01N 35/00732; G01N 35/1011; G06V 20/52; G01N 2035/00811; G01N 2035/1013

(57) ABSTRACT

A modular system for preparing a library of samples for sequencing may include an assay bay for performing an assay; a gantry system having a mover operatively coupled to the assay bay; and a camera attached to the gantry system and configured to capture images of the modular system, wherein the camera provides the images of the modular system to a computing device configured to analyze the images to determine a condition of the modular system.

### CROSS-REFERENCE TO RELATED APPLICATIONS

This application claims priority to U.S. Provisional Application No. 63/613,697, filed Dec. 21, 2023, which is incorporated herein by reference in its entirety.

### BACKGROUND

An automated library preparation system and method may have many parts and include many different steps. For example, library preparation may include the use of pipettes to dispense reagents from one container to another. Each part of a library preparation system must be properly configured at each step, and each step must be properly performed in order for the system to work.

Currently, inspection of the system at each step must be manually performed by a human. Any corrective action must also be prompted or undertaken by a human. Such inspection and correction may be time-consuming and counter to the purpose of creating and using an automated library preparation system. Moreover, some conditions may be difficult for a human to monitor, such as confirming the alignment of small parts such as pipette tips, or confirming the volume of a liquid in a container, as the differences may be too small to see with the naked eye. Thus, there exists a need for a system that is able to monitor conditions of the system and automatically perform corrective actions without human intervention.

### SUMMARY

Shortcomings of the prior art can be overcome and benefits as described later in this disclosure can be achieved through the provision of library preparation systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In one aspect, a modular system for preparing a library of samples for sequencing may include an assay bay for performing an assay; a gantry system having a mover operatively coupled to the assay bay; and a camera attached to the gantry system and configured to capture images of the modular system, wherein the camera provides the images of the modular system to a computing device configured to analyze the images to determine a condition of the modular system.

In another aspect, a method for performing quality control in a library preparation system may include (1) obtaining, at one or more processors, an image of one or more components of a library preparation system; (2) analyzing, by the one or more processors, the image to determine a condition of the one or more components; (3) verifying, by the one or more processors, a presence, location, or alignment of the one or more components based on the condition; and (4) causing, by the one or more processors, the library preparation system to perform a corrective action based on the condition of the one or more components.

In yet another aspect, a computing device for performing quality control in a library preparation system may include one or more processors and a non-transitory computer-readable memory storing instruction thereon. When executed by the one or more processors, the instructions cause the computing device to (1) obtain an image of one or more components of a library preparation system, (2) analyze the image to determine a condition of the one or more components, (3) verify a presence, location, or alignment of the one or more components based on the condition, and (4) cause the library preparation system to perform a corrective action based on the condition of the one or more components.

In another aspect, a non-transitory computer-readable memory stores instructions thereon that when executed by one or more processors, cause the one or more processors to (1) obtain an image of one or more components of a library preparation system, (2) analyze the image to determine a condition of the one or more components, (3) verify a presence, location, or alignment of the one or more components based on the condition, and (4) cause the library preparation system to perform a corrective action based on the condition of the one or more components.

In yet another aspect, a method for performing quality control in a library preparation system may include (1) obtaining, at one or more processors, an image depicting a presence of a reagent in a library preparation system; (2) analyzing, by the one or more processors, the image to detect the presence of the reagent and one or more characteristics of the reagent; and (3) at least one of: (i) verifying, by the one or more processors, that a threshold amount of the reagent has been dispensed from a component of the library preparation system; (ii) verifying, by the one or more processors, that the reagent is of sufficient quality based on the one or more characteristics; or (iii) causing, by the one or more processors, the library preparation system to perform a corrective action based on the one or more characteristics of the reagent.

In another aspect, a computing device for performing quality control in a library preparation system may include one or more processors and a non-transitory computer-readable memory storing instruction thereon. When executed by the one or more processors, the instructions cause the computing device to (1) obtain an image depicting a presence of a reagent in a library preparation system, (2) analyze the image to detect the presence of the reagent and one or more characteristics of the reagent, and (3) at least one of: (i) verify that a threshold amount of the reagent has been dispensed from a component of the library preparation system, (ii) verify that the reagent is of sufficient quality based on the one or more characteristics, or (iii) cause the library preparation system to perform a corrective action based on the one or more characteristics of the reagent.

In yet another aspect, a non-transitory computer-readable memory stores instructions thereon that when executed by one or more processors, cause the one or more processors to (1) obtain an image depicting a presence of a reagent in a library preparation system, (2) analyze the image to detect the presence of the reagent and one or more characteristics of the reagent, and (3) at least one of: (i) verify that a threshold amount of the reagent has been dispensed from a component of the library preparation system, (ii) verify that the reagent is of sufficient quality based on the one or more characteristics, or (iii) cause the library preparation system to perform a corrective action based on the one or more characteristics of the reagent.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect described herein. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a schematic implementation of another system that can be used to implement the system of FIG. 1.

FIG. 3 is an isometric view of a system that can be used to implement the system of FIG. 1.

FIG. 4 depicts an image of a row of tips attached to a contact dispenser, where some of the tips are misaligned relative to each other.

FIG. 5 depicts an image of a row of tips attached to a contact dispenser, where some of the tips include a liquid such as a reagent.

FIG. 6 depicts a graphical display of different colors of a reagent at different concentrations.

FIG. 7 is a flow diagram of an example method for determining a condition of component, which can be implemented in a computing device, such as the controller of FIG. 1.

FIG. 8 is a flow diagram of an example method for determining characteristics of a reagent, which can be implemented in a computing device, such as the controller of FIG. 1.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

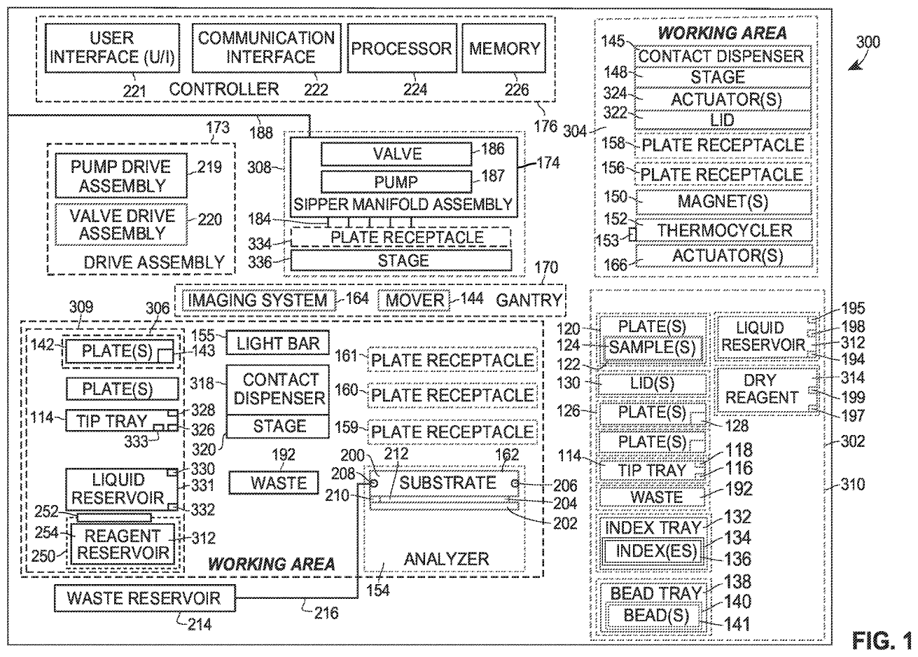

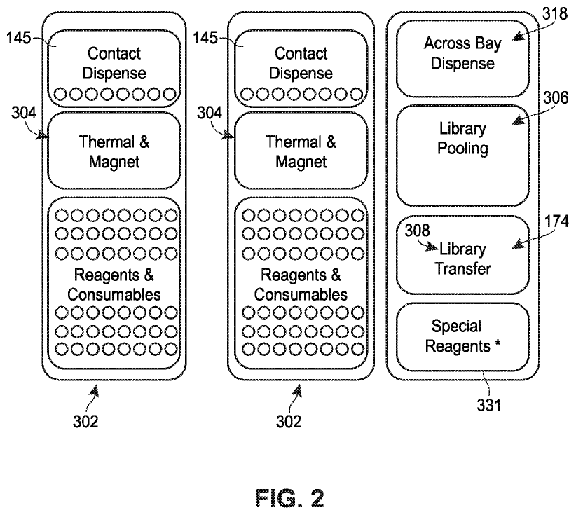

FIG. 1 illustrates a schematic diagram of an implementation of a system 300 in accordance with the teachings of this disclosure. The system 300 can be used to automatically, easily, and efficiently prepare DNA libraries for sequencing applications, for example. The system 300 includes a consumables area 302, a first working area 304, a second working area 306, and a loading area 308. The second working area 306 also includes a consumables area 309 in the implementation shown. The consumables area 302 and the first working area 304 may be referred to as a first bay (e.g., a first assay bay) and the second working area 306 may be referred to as a common bay. The system 300 may include any number of consumables areas 302 and a corresponding number of first working areas 304. The system 300 may include two consumables areas 302 and two first working areas 304 as shown in FIG. 2. Other numbers of working areas may be used. If more than one consumables area 302/first working area 304 are included, the system 300 can perform a corresponding number of workflows at the same time and/or at different times. One workflow (e.g., one assay) may be performed at one of the first working areas 304 and another workflow (e.g., a second assay) can be performed at another one of the first working areas 304 as an example.

The system 300 may perform DNA library preparation workflows that include amplification processes, cleanup processes, quantification processes, library normalization processes, pooling processes, denaturing processes, and/or diluting processes in some implementations. The loading area 308 may be associated with loading and/or transferring a prepared sample to a system such as a sequencing system and/or a next generation sequencing system. The first working area 304 may be associated with amplification processes and cleanup processes and the second working area 306 may be associated with quantification processes, library normalization processes, pooling processes, denaturing processes, and/or diluting processes.

The system 300 may perform workflows such as whole genome sequencing (WGS) workflows, DNA & RNA enrichment workflows, methylation workflows, split-pool amplicon workflows, and/or amplicon workflows. The DNA library preparation workflow can be performed on any number of samples such as between one sample and twenty four samples. The system 300 thus allows for variable batch processing.

The consumable area(s) 302 and/or 309 may be used to load and store reagents and consumables needed for a library preparation process, including, disposable tips, wet or dry assay specific reagents, wet or dry bulk reagents, and reaction plates and wells. The consumables area 302 includes a consumables receptacle 310 that is shown receiving a tip tray 114 having a first tip 116 and a second tip 118, a first plate 120 having a well 122 containing a sample 124, and a second plate 126 having a well 128. The consumables receptacle 310 may be a drawer that can be pulled out from the system 300 and loaded with the consumables 114, 116, 118, 120, 126. The consumables receptacle 310 is also shown having a lid 130, an index tray 132 having a well 134 containing indexes 136, a bead tray 138 having a well 140 containing beads 141, a liquid reservoir 312, and a dry reagent reservoir 314. One or more of these reagents 136 and/or 141 may be lyophilized and included with the dry reagent reservoir 314. The second working area 306 may also have a tip tray 114 and a third plate 142 having a well 143.

The first plate 120, the second plate, 126, the third plate 142, the index tray 132, and/or the bead tray 138 may be a stack of the corresponding plates 120 and/or 126 and/or trays 132 and/or 138. The first plate 120, the second plate, 126, and the third plate 142 may be stacked in some implementations while the index tray 132 and/or the bead tray 138 may not be stacked. Other approaches may prove suitable. The tip tray 114 may have a plurality of the first tips 116, a plurality of the second tips 118, and/or one or more tips that are different sizes from the first tips 116 and/or the second tips 118. The tips in the tip tray 114 may be reusable for at least multiple portions of a workflow, as will be discussed in greater detail below. While the tip tray 114 is mentioned having the first tip 116 and the second tip 118, the tip tray 114 can have any number of tips such as 24 tips. The plates 120, 126, 142 may have any number of wells, however.

While the plates 120 and 126 are mentioned having a single well 122, 128, the plates 120, 126 may have a plurality of wells such as 24 wells. The plates 120, 126 may include a 2×12 array of wells that allow for side access for all wells in some implementations. The plates 120, 126 being implemented by a 2×12 array allows a fill level/bubbles to be inspected in every well with side-view computer vision, increases heat transfer in heating (PCR) operations, and opportunities in magnetic pull down operations.

The system 300 includes a mover 144 and the first working area 304 includes a contact dispenser 145, a stage 148, a magnet 150, and a thermocycler 152. The contact dispenser 318 may be included in the first working area 304 in some implementations. The contact dispenser 145 may be movable to aspirate/dispense liquid to the consumables area 302 and/or to the first working area 304.

The stage 148 may be an x-z stage, such that the stage 148 is movable in the x and z directions (but not in the y direction). The stage 148 and the contact dispenser 145 may be movable to aspirate and/or dispense fluid between and above the consumables area 302 and the first working area 304 as a result. The contact dispenser 145 may, for example, move linearly in the x direction, which thereby reduces the risk of cross-contamination (between different samples) and allows some or all of the tips employed in the system 300 to be reusable for at least part of the processes performed by the system 300. The stage 148 may be implemented differently, however.

The second working area 306 includes an analyzer area 154, and the system 300 also includes a contact dispenser 318 and a stage 320 in the implementation shown.

The stage 320 may be referred to as a cross-bay gantry. The contact dispenser 318 may additionally or alternatively be implemented by a non-contact dispenser for aspiring/dispensing throughout the system 300. The dispenser 318 and the stage 320 can operate in the first working area 304 and the second working area 306.

The contact dispenser 318 may be movable to aspirate/dispense liquid to the consumables area 302, to the first working area 304, and/or to the second working area 306. The contact dispenser 318 may carry two tips (or two sets of tips) in some implementations, where one of the tips can hold a first volume of fluid and the other one of the tips can hold a second volume of fluid. The contact dispenser 318 may include two contact dispensers, where each dispenser carries one of tips. The two contact dispensers may be independently movable relative to one another. The first volume may be about 50 microliters and the second volume may be about 500 microliters.

The stage 320 may be an x-y-z stage, such that the mover 144 is movable in the x, y, and z directions. The stage 320 and the contact dispenser 318 may be movable to aspirate and/or dispense fluid between and above the consumables area 302, the first working area 304, and/or the second working area 306 as a result.

The mover 144 may be attached to a cross-bay gantry 170. The mover 144 may include a robotic arm and/or include grippers. The stage 320 may carry the mover 144 and the contact dispenser 318 in some implementations.

The second working area 306 may also include a light bar 155 that may be used to degrade oligonucleotides. The first working area 304 may additionally or alternatively include the light bar 155 in some implementations. The light bar 155 may be a high power ultraviolet light (UV) light bar that is regularly used throughout a workflow to repeatedly degrade oligonucleotides to deter cross contamination in some implementations.

The first working area 304 has a first plate receptacle 156 and a second plate receptacle 158, the second working area 306 has a third plate receptacle 159, a fourth plate receptacle 160, and a fifth plate receptacle 161, and the analyzer area 154 includes a substrate 162 in the implementation shown. The analyzer area 154 may be implemented differently, however, to perform quantification processes in other implementations. The analyzer area 154 may the substrate 162 that is implemented by a well plate in which a portion of the sample and a dye are dispensed as an example.

The first plate receptacle 156 may include a thermal block defining well receptacles and the thermocycler 152 can be positioned beneath the well receptacles. The thermocycler 152 may be positioned beneath the first plate receptacle 156 in some implementations. A heat sink 153 is shown coupled to the thermocycler 152. The heat sink 153 may be omitted, however.

The plate receptacles 156, 158, 159, 160, 161 may be referred to as plate stations. While five plate receptacles 156, 158, 159, 160, 161 are shown, any number of plate receptacles may be included such as six plate receptacles.

The second working area 306 also includes a reagent receptacle 250 having an access opening 252. A reagent reservoir 254 is shown received within the reagent reservoir 306. The first working area 304 may additionally or alternatively include a reagent receptacle 250 having an access opening 252. The reagent receptacle 250 may be refrigerated and may be a drawer that can be pulled out from the system 300 and loaded with the reagent reservoir 254. The reagent reservoir 254 may be accessed through the access opening 252 by the contact dispenser 318 to aspirate reagent from the reagent reservoir 254, for example.

The loading area 308 includes a sipper manifold assembly 174 in the implementation shown. The sipper manifold assembly 174 may be referred to as a sample sipper manifold assembly. The sipper manifold assembly 174 may include sippers 184. Any number of sippers 184 may be included such as between two sippers 184 and sixteen sippers 184 as an example. The sipper manifold assembly 174 may be coupled to a corresponding number of the flow cells of another system (see FIG. 24, for example) via sippers 184. The sipper manifold assembly 174 includes a plurality of ports in some implementations where each port of the sipper manifold assembly 174 may receive one of the sippers 184. The sippers 184 may be referred to as fluidic lines. The sipper manifold assembly 174 also includes a valve 186 that may be selectively actuated to control the flow of fluid through a fluidic line 188. The sipper manifold assembly 174 also includes a pump 187 to selectively flow the prepared sample from a well 128, 143 through the sipper 184, through the fluidic line 188, and out of the system 300 to another system. The other system may be used to perform an analysis on one or more samples of interest. The sample may include one or more DNA clusters that are linearized to form a single stranded DNA (sstDNA). The other system may be sequencing system and/or a next generation sequencing system, as an example.

The valve 186 may be implemented by a rotary valve, a pinch valve, a flat valve, a solenoid valve, a check valve, a piezo valve, etc. Other fluid control devices may prove suitable. The pump 187 may be implemented by a syringe pump, a peristaltic pump, and/or a diaphragm pump. Other types of fluid transfer devices may be used, however. The controller 176 is electrically and/or communicatively coupled to components of the system 300 to perform various functions as disclosed herein. The sipper manifold assembly 174 may alternatively be omitted.

The actuator 166 can move the magnet 150 between an upward position where the magnet 150 affects any plate positioned on the first plate receptacle 156 and a downward position where the magnet 150 does not affect any plate positioned on the first plate receptacle 156. The magnet 150 being moved relative to the first plate receptacle 156 and any plate 120, 126, 142 positioned on the first plate receptacle 156 allows less area on the first working area 304 to be consumed. The magnet 150 can moreover be moved with relatively higher confidence as compared to an alternative approach to moving one of the plates 120, 126, 142 filled with samples to a separate magnet station. The magnet 150 may be implemented by a halbach array configuration to strengthen and focus the corresponding magnetic fields.

The mover 144 moves the first plate 126 from the consumables area 302 to the first plate receptacle 156. Different wells 122 of the first plate 120 may contain different samples 124. The samples 124 may be a biological sample derived from a human, animal, plant, bacteria, virus, or fungi. Other sources of obtaining the biological samples may prove suitable. The mover 144 may be attached to a gantry 170 having grippers that can pick-and-place objects such as the plates 120, 126 and/or the trays 132, 138 between different areas 102, 304, 306, 308 of the system 300. The mover 144 may be implemented in different ways, however.

An imaging system 164 may be attached to the gantry 170 or to the mover 144. The imaging system may be a visible light camera. The imaging system 164 may image various parts of the system to identify conditions in the system. For example, the imaging system 164 may capture images of the tips 116, 118 attached to the contact dispenser 145 to determine an alignment of the tips, or to determine a quality of reagent in a first tip 116 or second tip 118.

The stage 148 aligns the contact dispenser 145 with the tip tray 114 and the contact dispenser 145 couples with the first tip 116 from the tip tray 114. While the contact dispenser 145 is mentioned coupling with one first tip 116, the contact dispenser 145 may couple with a number of the first tips 116 that corresponds to the number of the wells 122 in the first plate 120 and/or the number of the wells 122 in the first plate 120 containing the sample 124. The first tip 116 may be a smaller pipette tip that is used to move smaller fluid volumes and the second tip 118 may be a larger pipette tip that is used to move larger fluid volumes, for example. Each of the first tip 116 and/or the second tip 118 may be exposed to a single sample during a workflow reducing the likelihood of cross-contamination and reducing the need to obtain a new tip after each operation. In some library preparation workflows, for example, each of the first tip 116 and/or the second tip 118 may be used through an entire workflow. The contact dispenser 145 may couple with and/or use different ones of the tips 116, 118 depending on the workflow and/or the processes within a workflow that the system 300 is implementing.

In one example workflow, the stage 148 aligns the contact dispenser 145 with the index tray 132 and the contact dispenser 145 aspirates the indexes 136 from the index tray 132 using the first tip 116. The stage 148 can then align the contact dispenser 145 with the first plate 120 and the contact dispenser 145 dispenses the indexes 13 into the well 122 of the first plate 120. The mover 144 moves the lid 130 from the consumables area 302 and places the lid 130 on the first plate 120 to cover the well 122 of the first plate 120 with the lid 130. The first working area 304 also includes a lid 322 and an actuator 324. The lid 322 may be referred to as a cover and/or a door. The actuator 324 may move the lid 322 in operation relative to the plate receptacle 156 to cover the plate receptacle 156 during amplification processes, for example. The lid 322 may thus be positioned to enclose the first plate 120 during the amplification processes. The lid 130 and/or the lid 322 may enclose the first plate 120 during the amplification processes.

The thermocycler 152 is aligned with the first plate receptacle 156 and the thermocycler 152 amplifies the sample 124 within the well 122 of the first plate 120. The thermocycler 152 and/or the magnet 150 can act on a plate 120, 126 received at the first plate receptacle 156 in the implementation shown. The thermocycler 152 may alternatively be spaced from the magnet 150.

The actuator 324 can move the lid 322 off of the first plate 120 and/or the mover 144 can move the lid 130 from the first plate 120 to the consumables area 302 after the amplification processes are complete. The consumables area 302 includes a waste 192 that can receive used consumables such as, for example, the lid 130. The lid 130 may alternatively be reused, however. The waste 192 may be a waste tray having an absorbent material to absorb liquid waste.

The system 300 may perform cleanup processes after the amplification processes are performed. The stage 148 aligns the contact dispenser 145 with the bead tray 138 and the contact dispenser 145 aspirates the beads 141 from the bead tray 138. The contact dispenser 145 may aspirate the beads 141 using the same first tip 116 used to aspirate the indexes 136. The contact dispenser 145 may alternatively use another one of the first tips 116 or one of the second tips 118 to aspirate the beads 141.

The stage 148 aligns the contact dispenser 145 with the first plate 120 and the contact dispenser 145 dispenses the beads 141 into the well 140 of the first plate 120 as part of the cleanup process. The stage 148 aligns the contact dispenser 145 with the liquid reservoir 312 and the contact dispenser 145 aspirates first reagent 194 from the liquid reservoir 312. The stage 148 then aligns the contact dispenser 145 with the first plate 120 and the contact dispenser 145 dispenses the first reagent 194 into the well 122 of the first plate 120. The contact dispenser 145 may alternatively aspirate hydrating liquid 195 from the liquid reservoir 312 and then dispense the hydrating liquid 195 into dried reagent 197 contained within the dry reagent reservoir 314 to rehydrate the dried reagent 197 and form the first reagent 194. The contact dispenser 145 may pipette mix the dried reagent 197 and the hydrating liquid 195. The first reagent 194 may be a bead buffer and the sample 124 may bind to the beads 141 in the presence of the bead buffer. The contact dispenser 145 may be able to jet dispense with adequate liquid velocity to enable jet mixing in some implementations. The system 300 may also include a shaker to enable mixing.

The stage 148 aligns the contact dispenser 145 with the tip tray 114 and the contact dispenser 145 places the first tip 116 in the tip tray 116 and the contact dispenser 145 then couples with the second tip 118 from the tip tray 114. While the contact dispenser 145 is mentioned coupling with one second tip 118, the contact dispenser 145 may couple with a number of the second tips 118 that corresponds to the number of the wells 122 in the first plate 120 and/or the number of the wells 122 in the first plate 120 containing the sample 124.

The actuator 166 moves the magnet 150 toward the plate receptacle 156 and the magnet 150 draws the beads 141 toward the magnet 150. The beads 141 and the sample 124 bound to the beads 141 may be positioned toward the bottom of the well 122 of the first plate 120 or on a side(s) of the well 122. The tips 116 and/or 118 may easily access the well 122 if the beads 141 are on the side of the well 122. The magnet 150 may cause the beads 141 to be in any position within the well 122, however.

The stage 148 aligns the contact dispenser 145 with the first plate 120 and the contact dispenser 145 aspirates the first reagent 194 from the well 122 of the first plate 120. The contact dispenser 145 may dispense the first reagent 194 aspirated from the well 122 of the first plate 120 into the waste 192.

The stage 148 aligns the contact dispenser 145 with the liquid reservoir 312 and the contact dispenser 145 aspirates second reagent 198 from the liquid reservoir 312 and the stage 148 then aligns the contact dispenser 145 with the first plate 120 and the contact dispenser 145 dispenses the second reagent 198 into the well 122 of the first plate 120. The contact dispenser 145 may alternatively aspirate hydrating liquid 195 from the liquid reservoir 312 and then dispense the hydrating liquid 195 into a dried reagent 199 contained within the dry reagent reservoir 314 to rehydrate the dried reagent 199 and form the second reagent 198. The second reagent 198 may be an elution buffer that releases the sample 124 from being bound to the beads 141 and, specifically, releases DNA associated with the sample 124 from being bound to the beads 141.

The mover 144 moves the second plate 126 from the consumables area 302 to the second plate receptacle 158. The system 300 can use the second plate 126 for a transfer operation. The second plate 126 may alternatively remain in the consumables area 302 during the transfer operation. The actuator 166 moves the magnet 150 toward the second plate receptacle 158 to draw the beads 141 toward the magnet 150 and, thus, provide a substantially bead-free eluate solution comprising the second reagent 198 and the sample 124 within the well 122.

The stage 148 aligns the contact dispenser 145 with the first plate 120 and the contact dispenser 145 aspirates the second reagent 198 and the sample 124 from the well 122 of the first plate 120 using the second tip 118, for example. The stage 148 aligns the contact dispenser 145 with the second plate 126 and the contact dispenser 145 dispenses the second reagent 198 and the sample 124 into the well 128 of the second plate 126. The second plate 126 may alternatively be positioned in the consumables area 302 when the contact dispenser 145 dispenses the second reagent 198 and the sample 124 into the well 128 of the second plate 126. The second plate receptacle 158 may be omitted from the second working area 306 in such implementations.

The system 300 may perform the quantification processes after the cleanup processes are performed. The mover 144 moves the second plate 126 from the first working area 304 to the plate receptacle 159 of the second working area 306 to initiate the quantification processes in some implementations. The mover 144 may alternatively move the second plate 126 from the consumables area 302 to the plate receptacle 159 of the second working area 306 to initiate the quantification processes in implementations when the second plate 126 remains in the consumables area 302 during the transfer operations.

The stage 320 aligns the contact dispenser 318 with the tip tray 114 of the second working area 306 in some implementations and the contact dispenser 145 couples with a tip 326 from the tip tray 114.

The substrate 148 may be a plate having a well. The substrate may be a consumable that is disposed of after use. The imaging system 164 may be spaced from the substrate 148 and coupled to a portion of the system 300 such as a frame of the system 300. The imaging system 164 may alternatively be carried by a stage.

The stage 320 aligns the contact dispenser 318 with the second plate 126 to perform the quantification processes and the contact dispenser 318 aspirates a portion of the second reagent 198 and the sample 124 from the well 128 of the second plate 126. The portion of the second reagent 198 and the sample 124 may be about 2 μL.

The stage 320 aligns the contact dispenser 318 with the substrate 162 and the contact dispenser 318 dispenses the portion of the second reagent 198 and the sample 124 into a well of the substrate 162 as an example. A dye may also be dispensed into the well of the substrate 162 by the contact dispenser 318. The imaging system 164 obtains image data of the portion of the second reagent 198 and the sample 124 within the well of the substrate 162. The imaging system 164 and/or the system 300 uses the image data to determine a concentration of the sample 124. The mover 144 may move the substrate 162 to the waste 192 of the consumables area 309 of the second working area 306.

The substrate 162 may alternatively be implemented by a pair of plates 200, 202 between which a gap 204 is defined. The substrate 162 in such an implementation includes an inlet 206 and an outlet 208 in fluid communication with the gap 204 and a seal 210 positioned between the pair of plates 200, 202. The plates 200, 202 and the seal 210 define a channel 212 between the inlet 206 and the outlet 208. A waste reservoir 214 may be fluidly coupled to the outlet 208 of the substrate 162 by a fluidic line 216.

In the alternative implementation of the substrate 162, the stage 320 aligns the contact dispenser 318 with the inlet 206 of the substrate 162 and the contact dispenser 318 dispenses the portion of the second reagent 198 and the sample 124 into the inlet 206 of the substrate 162. The portion of the second reagent 198 and the sample 124 may flow and/or be positioned between the inlet 206 and the outlet 208 in this implementation and the imaging system 164 obtains image data of the portion of the second reagent 198 and the sample 124. The imaging system 164 and/or the system 300 uses the image data to determine a concentration of the sample 124. Negative pressure, oil, and/or another substance may be used to urge the portion of the second reagent 198 and the sample 124 between the inlet 206 and the outlet 208. The first plate 200 may alternatively be hingably coupled or removably coupled to the second plate 202 to allow the contact dispenser 318 to dispense the portion of the second reagent 198 and the sample 124 onto the second plate 202 prior to the first plate 200 being positioned overtop of the second plate 202. The system 300 may perform quantification processes in different ways, however.

The system 300 may perform the normalization processes after the quantification processes are performed. The stage 320 aligns the contact dispenser 318 to initiate the normalization processes in some implementations. The contact dispenser 318 aspirates a diluent 330 from a liquid reservoir 331 of the second working area 306. The stage 320 then aligns the contact dispenser 318 with the second plate 126 and the contact dispenser 318 dispenses the diluent 330 into the well 128 of the second plate 126 to dilute the sample 124 based on the concentration of the sample determined. The sample 124 within the well 128 of the second plate 126 will have a concentration within a threshold value after the diluent 330 is added to the well 128 as a result. The diluent 330 may be a buffer.

The system 300 may perform the pooling processes after the quantification processes are performed. The stage 320 aligns the contact dispenser 318 with the tip tray 114 of the second working area 306 and the contact dispenser 318 places the tip 326 in the tip tray 114 and the contact dispenser 318 then couples with another tip 328 from the tip tray 114 to initiate the pooling processes in some implementations. The mover 144 moves a plate 142 from the second working area 306 to the plate receptacle 160 of the second working area 306. The stage 320 aligns the contact dispenser 318 with the second plate 126 and the contact dispenser 318 aspirates the sample 124 from the well 128 of the second plate 126. The stage 320 then aligns the contact dispenser 318 with the third plate 142 and the contact dispenser 318 dispenses the sample 124 into the well 143 of the third plate 142. Additional samples from other wells of the second plate 126 may be deposited into the well 143 of the third plate 142 in a similar manner to combine a plurality of normalized samples together. A single tip can be used for the pooling processes. The contact dispenser 318 may pipette from final archive library well directly to pool and, thus, unique tips per sample may be used.

The system 300 may perform the denaturing processes after the pooling processes are performed (though in some implementations, denaturing need not be performed). The stage 320 aligns the contact dispenser 318 with the tip tray 114 of the second working area 306 and the contact dispenser 318 places the tip 328 in the tip tray 114 and the contact dispenser 318 then couples with another tip 333 from the tip tray 114 to initiate the denaturing processes in some implementations. The contact dispenser 1318 may use the same tip 328 used during the pooling processes in some implementations, however. The stage 320 aligns the contact dispenser 318 with the liquid reservoir 331 and the contact dispenser 318 aspirates reagent 332 from the liquid reservoir 331. The stage 320 then aligns the contact dispenser 318 with the third plate 142 and the contact dispenser 318 dispenses the reagent 332 into the well 143 of the third plate 142 to denature the pooled and normalized samples. The reagent 332 may be Sodium hydroxide (NaOH). Other denaturing processes may prove suitable. For example, Formamide or an equivalent may be used during the denaturing processes.

The system 300 may dilute the pooled and denatured samples after the pooling and the denaturing processes are performed. The contact dispenser 318 aspirates a diluent 330 from a liquid reservoir 331 of the second working area 306. The stage 320 then aligns the contact dispenser 318 with the third plate 142 and the contact dispenser 318 dispenses the diluent 330 into the well 128 of the third plate 142 to dilute the sample 124 based on the concentration of the sample based on specifications of the sequencing system (e.g., the system 900) into which the sample is to be loaded. The pooled samples 124 within the well 143 of the third plate 142 will have a concentration within a threshold value after the diluent 330 is added to the well 143 as a result. The diluent 330 may be a buffer.

The system 300 may perform the loading processes after the denaturing processes and/or after the diluting processes are performed. The mover 144 moves the third plate 142 from the second working area 306 to a plate receptacle 334 of the loading area 308. The loading area 308 is shown including a stage 336 that can be used to move the plate receptacle 334 relative to the sipper manifold assembly 174. The sipper manifold assembly 174 flows the denatured samples from the well 128, 143 through the corresponding sipper(s) 184, through the fluidic line(s) 188, and out of the system 300 to another system for sequencing.

The system 300 also includes a drive assembly 173. The drive assembly 173 includes a pump drive assembly 219 and a valve drive assembly 220. The pump drive assembly 219 may be adapted to interface with the pump 187 to pump fluid from the reagent reservoir 110 to the non-contact dispenser 146. The valve drive assembly 220 may be adapted to interface with the valve 186 to control the position of the valve 186.

The controller 176 includes a user interface 221, a communication interface 222, one or more processors 224, and a memory 226 storing instructions executable by the one or more processors 224 to perform the various functionality discussed herein. The user interface 221, the communication interface 222, and the memory 226 are electrically and/or communicatively coupled to the one or more processors 224.

As described in more detail below, the controller 176 may direct the imaging system 164 to capture images of the contact dispenser 145, tips 116, 118 attached to the contact dispenser 145, reagents, samples, plates 128, or any other suitable components of the system 300. The controller 176 may then analyze the images to identify conditions in the library preparation system 300, such as whether the tips are aligned in a contact dispenser, whether the tips have been attached to the contact dispenser, the volume or quality of a reagent in a tip, etc. Then the controller 176 may communicate with components of the library preparation system 300 to perform corrective actions according to the identified conditions.

The controller 176 may be electrically and/or communicatively coupled to the components of the library preparation system 300 via a wired or wireless connection, such as the contact dispensers, actuators, thermocyclers, movers, grippers, valves, pumps, etc.

The controller 176 may transmit control signals to these components to control the components and perform actions in the library preparation system 300, such as aspirating and/or dispensing fluid, attaching or removing tips from the contact dispenser, etc.

In an implementation, the user interface 221 receives input from a user and provides information to the user associated with the operation of the system 300 (e.g., information about the analysis taking place). The user interface 221 may include a touch screen, a display, a key board, a speaker(s), a mouse, a track ball, and/or a voice recognition system. The touch screen and/or the display may display a graphical user interface (GUI).

In an implementation, the communication interface 222 enables communication between the system 300 and a remote system(s) (e.g., computers) using a network(s). The network(s) may include an intranet, a local-area network (LAN), a wide-area network (WAN), the intranet, etc. Some of the communications provided to the remote system may be associated with an amplification process(es), a cleanup process(es), a library normalization process(es), a pooling process(es), a denaturing process(es), a loading process(es), and/or a correction process(es), etc. generated or otherwise obtained by the system 300. Some of the communications provided to the system 300 may be associated with an amplification process(es), a cleanup process(es), a library normalization process(es), a pooling process(es), a denaturing process(es), a loading process(es), and/or a correction process(es) to be executed by the system 300.

The one or more processors 224 and/or the system 300 may include one or more of a processor-based system(s) or a microprocessor-based system(s). In some implementations, the one or more processors 224 and/or the system 300 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 226 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

FIG. 2 is a schematic implementation of another system 400 that can be used to implement the system 300 of FIG. 1. The system 400 of FIG. 2 is similar to the system 300 of FIG. 1. Like the system 300, the system 400 of FIG. 2 includes two consumables areas 302, two first working areas 304, one second working area 306, and one loading area 308. Each of the first working areas 304 may perform the amplification process(es) and cleanup process(es) and the second working area 306 may perform the quantification processes, the library normalization processes, the pooling processes, the denaturing processes, and/or diluting processes. The sipper manifold assembly 174 may be used to transfer the prepared library to another system such as a sequencing instrument.

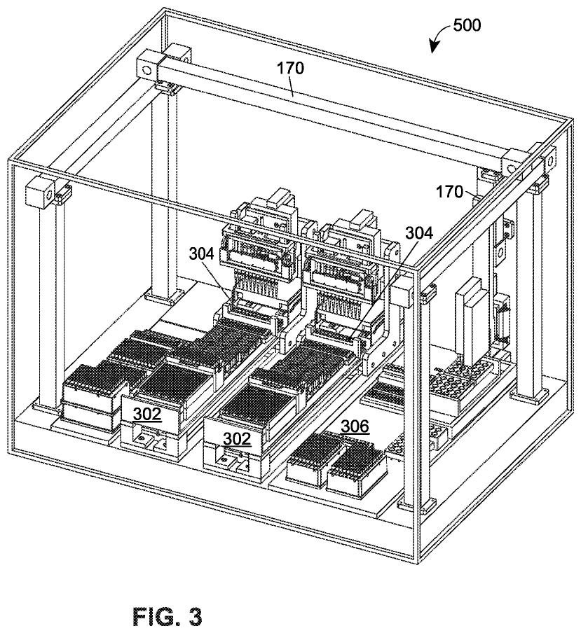

FIG. 3 illustrates an isometric view of a system that can be used to implement the system 300 of FIG. 1. The system 500 shown is a library preparation system and includes a consumables area 302, assay bays 304, a common bay 306, and a cross-bay gantry 170. As mentioned above, an imaging system, similar to the imaging system 164, may be attached to the cross-bay gantry 170. Additionally, the system 500 may include a controller having a processor, a memory, and a communication interface, similar to the controller 176. The controller may be communicatively coupled to the imaging system, and may transmit control signals to components of the library preparation system 500, such as contact dispensers, actuators, thermocyclers, movers, grippers, valves, pumps, etc.

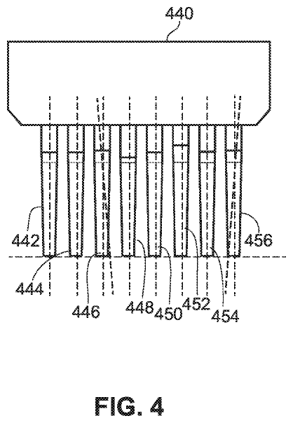

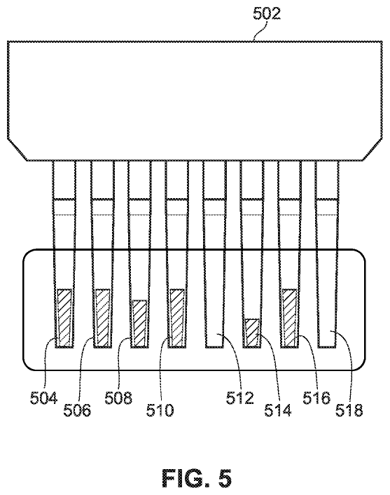

As mentioned above, the imaging system 164 captures images of the library preparation system 300 to identify conditions in the system 300. These conditions may include conditions related to hardware components within the system 300, such as contract dispensers, tips, plates, wells, movers, grippers, etc. The conditions may also include conditions related to fluids in the system, such as reagents, samples, etc. FIGS. 4 and 5 depict example images captured by the imaging system 164, which may be analyzed by the controller 176 to identify conditions in the system 300. This allows the controller 176 to take corrective action and resolve these identified conditions.

FIG. 4 depicts an example image of a row of tips attached to a contact dispenser within the library preparation system 300. Multiple tips 442-456 may be attached to the contact dispenser head 440 which is configured to hold tips. The tips 442-456 are configured to attach to the contact dispenser head 440, such that they are parallel to each other, perpendicular to the contact dispenser head 440, and face downwards from the top of the contact dispenser head 440. Additionally, each tip is the same length such that the bottom of each tip should be at the same height. When the tips are attached correctly, the tips may be referred to as “vertically aligned.” When the tips are not attached correctly and are misaligned, one of the tips may not be parallel to the other vertically aligned tips. Accordingly, the bottom of the misaligned tip may be above the bottom height for the other tips. Additionally, a tip may be parallel to the other tips and perpendicular to the contact dispenser head 440, but may have a bottom height which is above or below a predetermined height. This may be because the tip is attached too tightly or too loosely to the contact dispenser head 440. In this scenario, the tip may be misaligned.

As shown in FIG. 4, the tips 442, 444, 450, and 454 are vertically aligned such that the bottom of each tip 442, 444, 450, and 454 is even with the other tips with a bottom height at the predetermined height, each of the tips 442, 444, 450, and 454 is parallel to the other vertically aligned tips, and each tip 442, 444, 450, and 454 is perpendicular to the contact dispenser head 440.

On the other hand, tips 446, 448, 452, and 456 are misaligned. More specifically, the bottom height of tip 448 is below the predetermined height indicating the tip 448 is attached too loosely to the contact dispenser head 440. The bottom height of tip 452 is above the predetermined height indicating the tip 452 is attached too tightly to the contact dispenser head 440. Tips 446 and 456 are tilted at slight angles, such that they are not perpendicular to the contact dispenser head 440 and are not parallel to the other tips 442, 444, 450, and 454. While not depicted, a tip may not be perpendicular to the contact dispenser head 440 and may have a bottom height which is above or below the predetermined height.

An imaging system such as the imaging system 164 of FIG. 1 may be configured to capture an image of the contact dispenser head 440 and the tips 442-456. For example, the imaging system may be attached to a mover in the cross-bay gantry 170. The mover may move to a position within the library preparation system 300 so that the imaging system is facing the contact dispenser head 440. For example, the mover may move within a threshold distance of the contact dispenser head 440 to a position in which a front or rear view image of the contact dispenser head 440 can be captured.

The imaging system may provide the image to the controller 176. Then a processor within the controller 176, such as the processor 224 of FIG. 1 may analyze the image of the contact dispenser 440 to determine the presence and/or alignment of the tips 442-456.

In some embodiments, the processor 224 analyzes the images to identify conditions of the library preparation system, such as the presence, absence, or alignment of tips on the contact dispenser head 440. To identify the conditions, the processor 224 analyzes images and identifies objects within the images. In this example, the processor 224 may identify the contact dispenser head 440 and the tips attached to the contact dispenser head. To identify each object, the processor 224 identifies features within each object, such as the geometry of the object, colors within the object, etc.

These features may be identified by detecting stable regions within the object that are detectable regardless of blur, motion, distortion, orientation, illumination, scaling, and/or other changes in camera perspective. The stable regions may be extracted from the object using a scale-invariant feature transform (SIFT), speeded up robust features (SURF), fast retina keypoint (FREAK), binary robust invariant scalable keypoints (BRISK), or any other suitable computer vision techniques. In some embodiments, keypoints may be located at high-contrast regions of the object, such as edges within the object. A bounding box may be formed around a key point and the portion of the object created by the bounding box may be a feature.

The processor 224 may compare the features identified for the object to features from template objects (also referred to herein as “template features”) using image classification and/or machine learning techniques. At least some of template objects may represent a tip, a contact dispenser head, or other hardware components within the library preparation system 300. The machine learning techniques may include linear regression, polynomial regression, logistic regression, random forests, boosting, nearest neighbors, Bayesian networks, neural networks, support vector machines, or any other suitable machine learning technique. Then each of these template features may be compared to the features in the object.

In some embodiments, the template features may be compared to the features of the object using a nearest neighbors algorithm. The nearest neighbors algorithm may identify template features which are the closest to the features of the object by creating numerical representations of the features to generate feature vectors, such as the pixel length of a tip, RBG pixel values for a tip, etc. The numerical representations of the features or feature vectors of the object may be compared to the feature vectors of template objects to determine a vector distance between the features of the object and each template object. The processor 224 may then determine whether the object depicts a particular hardware component within the library preparation system 300 based on the amount of similarity, or the vector distance in the nearest neighbors algorithm, between the features for the object and the features for template objects that represent the particular hardware component (e.g., a tip). If the closest template objects represent a particular hardware component, the object is identified as the particular hardware component.

In this example, the processor 224 may identify a contact dispenser head 440 and eight tips 442-456 in the image. The processor 224 may also obtain the pixel boundaries of each identified object. Then the processor 224 determines whether the tips 442-456 are vertically aligned according to the pixel boundaries of the tips and the pixel boundaries of the contact dispenser head 440. For example, the processor 224 may generate a line from the bottom left corner of the contact dispenser head 440 to the bottom right corner of the contact dispenser head 440. For a tip 442-458, the processor 224 may generate a line from the top of the tip to the bottom of the tip. Then the processor 224 may determine the angle between the intersecting lines to determine whether the lines are perpendicular. Additionally, the processor 224 may determine the distance of the bottom of the tip from the bottom of the contact dispenser head 440. Then the processor 224 may compare this distance to the predetermined height. If the bottom height of the tip is at the predetermined height and the tip is perpendicular to the contact dispenser head 440, the processor 224 determines the tip is vertically aligned.

On the other hand, if the bottom height of the tip is not at the predetermined height or the tip is not perpendicular to the contact dispenser head 440, the processor 224 may determine that the tip is misaligned and may identify a condition in the system 300.

If the processor 224 determines that at least one tip is misaligned, the system may perform a corrective action. For example, the corrective action may be to remove the misaligned tips 446, 448, 452, and 456 from the contact dispenser head 440 and attempt to recouple the tips 446, 448, 452, and 456 to the contact dispenser head 440.

To carry out this corrective action, the controller 176 may transmit a control signal to a component in the library preparation system to cause the contact dispenser head 440 to release the misaligned tips 446, 448, 452, and 456. For example, the controller 176 may transmit the control signal to the contact dispenser head 440. Then the controller 176 may transmit control signals to a gripper or robotic arm to pick up and reattach the tips 446, 448, 452, and 456 to the contact dispenser head 440. Then after the tips have been reattached to the contact dispenser head 440, the imaging system 164 may capture additional images of the contact dispenser, and the processor 224 may analyze the images to determine whether the tips are now vertically aligned. The controller 176 may repeat this process until each of the tips are vertically aligned.

In some implementations, the corrective action may include removing tips from a contact dispenser, attaching tips to a contact dispenser, or both. If the contact dispenser is meant to have tips attached, the corrective action may include attaching tips to the contact dispenser. If the contact dispenser is not meant to have tips attached, the corrective action may include removing tips from the contact dispenser. If the tips attached to the contact dispenser are misaligned, the corrective action may include both removing and attaching tips to the contact dispenser.

In some implementations, the condition may include a plate being held by a gripper. The imaging system 164 may capture an image of the plate being held by a gripper. The processor 224 may analyze the image using the techniques described above to determine that the plate is properly being held by a gripper (e.g., that the gripper is holding the plate in the correct position). For example, the processor 224 may identify objects in the image to determine whether the plate is in the consumables bay, the assay bay plate receptacle, the common bay plate receptacle, etc. The processor 224 may also analyze the boundaries of the objects to determine whether the plate is held parallel to the consumables bay, the assay bay plate receptacle, and/or the common bay plate receptacle, for example.

The example image and analysis depicted in FIG. 4 is just one example for ease of illustration only. In addition to determining whether the tips are vertically aligned, the processor 224 may identify objects in the image to determine whether there is a tip attached to the contact dispenser head 440, whether a tip has been removed from a contact dispenser head, whether a plate is properly being held by a gripper, or whether any other component in the system 300 is present, is in a specified location, and/or is properly aligned. In some implementations, the processor 224 may analyze multiple images of components to identify a particular condition. For example, if the processor 224 is determining whether a tip has been removed from a contact dispenser head 440, the processor 224 may obtain a first image to verify the presence of the tip attached to the contact dispenser head 440. Then the processor 224 may analyze a second image captured after the first image to determine whether the tip is no longer attached to the contact dispenser head 440. If the tip is no longer attached to the contact dispenser head 440, the processor 224 determines that the tip has been removed from the contact dispenser head 440.

In addition to identifying conditions related to hardware components in the system 300, the controller 176 may identify conditions related to fluids in the system, such as reagents, samples, etc. FIG. 5 depicts an image of a row of tips attached to a contact dispenser, where some of the tips include a liquid such as a reagent. The liquid may be dyed a particular color (e.g., blue) so that it may be easier to identify the liquid in the image. For example, a reagent may be dyed blue by a dye that does not react with the reagent and/or other chemicals and/or materials used in the library preparation process, such as methylene blue. In some implementations, the tip is clear to view the inside of the tip. In the example image of FIG. 5, the tips 504-518 are attached to a contact dispenser head 502.

Tips 504, 506, 510, and 514 all have the same volume of liquid, while the volume is lower for tips 508, 512, 514, and 518. Tips 512 and 518 do not include any liquid.

In some embodiments, a processor such as processor 224 of FIG. 1 analyzes the image to identify a condition related to the liquid within the tip. To identify a condition, the processor 224 analyzes images and identifies objects within the images. In this example, the processor 224 may identify the contact dispenser head 502, the tips 504-518 attached to the contact dispenser head, and the liquid within the tips. To identify each object, the processor 224 identifies features within each object, such as the geometry of the object, colors within the object, etc.

The features may be identified using the techniques described above, such as SIFT, SURF, FREAK, BRISK, or any other suitable computer vision techniques. The features of the image may be compared to the template features of template objects representing hardware components within the library preparation system 300. The template objects may also represent dyed liquids using the selected dye. The processor 224 may then determine whether the image depicts a particular hardware component or liquid based on the amount of similarity, or the vector distance in the nearest neighbors algorithm, between the features of the image and the features for template objects that represent the particular hardware component or liquid.

Then for an identified object, the processor 224 may determine characteristics of the object. For example, for a tip, the processor 224 may determine whether there is liquid inside the tip by comparing RGB pixel values within the pixel boundaries of the tip to a predetermined RGB pixel value or range of RGB pixel values associated with the selected dye. The processor 224 may also determine the volume of the reagent within the tip based on the number of pixels within the tip that match the predetermined RGB pixel value or range of RGB pixel values, the scale of the image, and/or the pixel height of the highest pixels that match the predetermined RGB pixel value or range of RGB pixel values relative to the bottom of the tip.

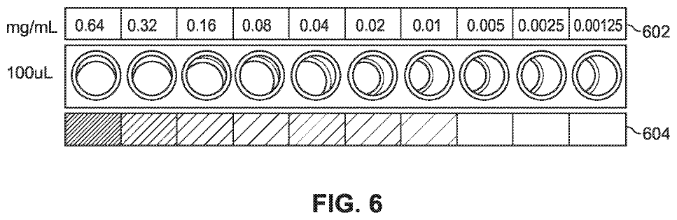

In some implementations, the processor 224 may determine the concentration of the reagent based on the RGB pixel values for the reagent. For example, darker blue colors may indicate higher concentrations than lighter blue colors. FIG. 6 depicts a chart of different color shades (e.g., of blue) representing different concentrations of reagent in a liquid. As shown in FIG. 6, each numerical concentration of reagent 602 corresponds to a different color or shade 604. The controller 176 may store corresponding RGB color values or ranges of RGB color values for each shade in a memory such as the memory 225 in FIG. 1. The controller 176 may also associate each shade with a concentration value, such as the concentration values in the chart.

Then when the processor 224 analyzes an image and identifies a reagent in the image, the processor 224 may compare the RGB color value for the reagent to the stored RGB color values corresponding to the different shades to determine the shade of the reagent. Then the processor 224 may determine the quality and/or concentration of the reagent within a tip, well, or container that is associated with the determined shade.

In some implementations, the processor 224 may use the color and/or shade of a reagent to determine other characteristics of the reagent, such as a quality metric for the reagent. For example, in some scenarios, a reagent may also include more than one color and/or shade when a lyophilized reagent has been added to a liquid but has not yet fully been mixed into the liquid, for example. The processor 224 may identify multiple shades of the reagent by for example, identifying multiple adjacent clusters of RGB pixel values which each correspond to a different shade but are within the range of RGB pixel values associated with the selected dye.

When the reagent has fully been mixed into the liquid, the reagent is of higher quality than when the reagent has not fully been mixed into the liquid. Therefore, the processor 224 may decrease the quality metric for each additional shade of the reagent that is identified. In this manner, the processor 224 may determine that the reagent is of sufficient quality based on the characteristics of the reagent.

Still further, the processor 224 may determine whether a threshold amount of the reagent has been dispensed from a component of the library preparation system 300 (e.g., a tip, a well, etc.) by obtaining a first image before the reagent was dispensed and a second image after the liquid has been dispensed and comparing the volumes of the reagent detected in each image. The processor 224 may also determine whether the reagent has been completely removed from the tip based on the color of the reagent and the color within the tip. For example, if the tip is clear and does not include any pixels within the pixel boundaries of the tip that match the predetermined RGB pixel value or range of RGB pixel values associated with the selected dye, the processor 224 may determine that the reagent has been completely removed from the tip.

Additionally, the processor 224 may determine whether some reagent adhered to the inner or outer surface of the tip (e.g., hang). The processor 224 may use the color of the reagent and any color located in and/or on a tip to identify the presence of any reagent in and/or on the tip. For example, the processor 224 may obtain an image captured by the imaging system at least a threshold time period after liquid had been dispensed from the tip. The processor 224 may analyze a portion of the image on the inside and outside edge of the pixel boundaries of the tip to determine whether pixels in this portion match the predetermined RGB pixel value or range of RGB pixel values associated with the selected dye. If a cluster of pixels in this portion match the predetermined RGB pixel value or range of RGB pixel values associated with the selected dye, the processor 224 may determine that some reagent adhered to the outside of the tip.

In some implementations, the controller 176 may perform a corrective action based on the characteristics of the reagent. For example, in response to determining that the volume of liquid in the tips is above a threshold volume or within a threshold range, the controller 176 may transmit a control signal to the contact dispenser to dispense the reagent from the tips into a well. Then in response to determining that at least some of the reagent adhered to the inside or outside of one of the tips, the controller 176 may transmit a control signal to the contact dispenser to aspirate the reagent back into the tip. Then the controller 176 may transmit another control signal to the contact dispenser to once again dispense the reagent from the tip into the well, so that the reagent that adhered to the outside of the tip is placed in the well.

For example, the contact dispenser may be an electronic pipette. The controller 176 may transmit control signals to a motor of the electronic pipette to aspirate liquid, dispense liquid, and/or remove tips from the electronic pipette. For example, the motor may turn in one direction to push down a plunger and dispense liquid and other direction to pull up the plunger and aspirate liquid. Another motor may turn in one direction to lock a tip in place, and in another direction to release the tip.

In another example, the controller 176 may transmit a control signal to a gripper or robotic arm to pick up a wipe and wipe a tip with an absorbent material to remove the excess liquid that adhered to the inner or outer surface of the tip.

In another example, the controller 176 may transmit a control signal to the contact dispenser to remove a tip from the contact dispenser, for example after a reagent has been dispensed from the tip, after the tip has been used more than a threshold number of times, after reagent adhered to the outside of the tip more than a threshold number of times, when the reagent may be reactive with a future liquid to be aspirated into the same tip, when the reagent is unable to be removed from the tip, etc.

While the examples illustrated in FIGS. 4-5 include images of reagents in a tip, these are merely a few example images for ease of illustration only. The imaging system 164 may capture images of a reagent in a tip, a well, or any other suitable container.

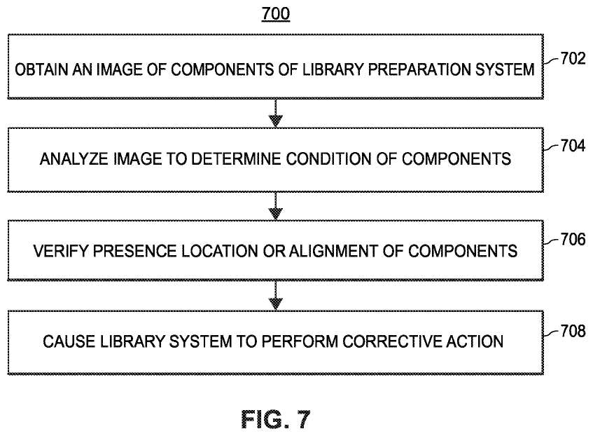

FIG. 7 is a flow diagram of an example method for performing quality control in a library preparation system. One or more steps of the computer-implemented method of 700 may be implemented as a set of instructions stored on a computer-readable memory and executable on one or more processors. The computer-implemented method 700 may operate in the environment illustrated in FIG. 1. For example, the method 700 may be implemented by the controller 176 of FIG. 1.

At block 702, a processor such as processor 224 of FIG. 1 may obtain an image of one or more components of a library preparation system. The image may be captured by an imaging system such as imaging system 164 of FIG. 1. The image may include a contact dispenser, a gripper, a tip, and/or a plate.

At block 704, the processor 224 may analyze the image to determine a condition of the one or more components. The processor 224 may analyze the image to identify an object in the image, such as a contact dispenser, a tip, a gripper, and/or a plate. Then the processor 224 may analyze characteristics of the object to determine the condition of the object, such as that a tip attached to a contact dispenser is misaligned.

At block 706, the processor 224 may verify the presence, location, or alignment of the one or more components based on the condition. The processor 224 may verify that a tip is coupled to the contact dispenser, that a tip has been removed from the contact dispenser, that the tip is vertically aligned with other tips in a row of tips, and/or that a height of the bottom of the tip is at a predetermined height.

At block 708, the processor 224 may cause the library preparation system to perform a corrective action based on the condition of the one or more components. For example, the processor 224 may transmit a control signal to cause the library preparation system to remove a tip from a contact dispenser and/or attach or reattach a tip to the contact dispenser.

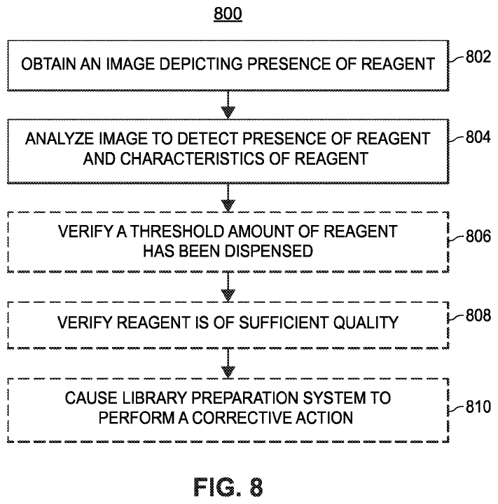

FIG. 8 is a flow diagram of another example method for performing quality control in a library preparation system. One or more steps of the computer-implemented method of 800 may be implemented as a set of instructions stored on a computer-readable memory and executable on one or more processors. The computer-implemented method 800 may operate in the environment illustrated in FIG. 1. For example, the method 800 may be implemented by the controller 176 of FIG. 1.

At block 802, the processor 224 may obtain an image depicting the presence of a reagent within the library preparation system. For example, the image may include reagent that has been aspirated into a tip.

At block 804, the processor 224 may analyze the image to detect the presence of the reagent and characteristics of the reagent. The processor 224 may utilize computer vision techniques to detect the presence and characteristics of the reagent. For example, the characteristics of the reagent may include a volume of the reagent in a tip. The processor 224 may identify the reagent by comparing the shape and/or color of an object within the image to template objects of dyed liquids. If the closest template objects represent a dyed liquid, the object is identified as the reagent.

At block 806, the processor 224 may optionally verify that a threshold amount of reagent has been dispensed from the contact dispenser. The processor 224 may analyze an image to identify that a tip is coupled to a contact dispenser. The processor 224 may then analyze the image to determine that the reagent has been completely removed from the contact dispenser (e.g., that there is no reagent inside or attached to the outside of a tip).

The processor 224 may identify the reagent's presence and/or an amount of reagent by analyzing the color of the reagent and the color inside the tip. In some implementations, the tip is clear to view the inside of the tip. Also in some implementations, the processor 224 may obtain multiple images of the tip before and after the reagent has been dispensed. In this manner, processor 224 may compare the images to determine that at first, the reagent was inside the tip, but in a subsequent image, the reagent had been dispensed and the presence of the reagent is not detected within the tip.

At block 808, the processor 224 may optionally verify that the reagent is of sufficient quality based on the characteristics of the reagent. The processor 224 may identify the quality of the reagent based on the color of the reagent. The quality of the reagent may include the concentration of the reagent in a liquid. The quality of the reagent may also be based on the number of color shades of the reagent indicating that the reagent has not fully been mixed into the liquid. The processor 224 may compare the RGB color value for the reagent to the stored RGB color values corresponding to the different shades to determine the shade of the reagent.

At block 810, the processor 224 may optionally transmit a control signal to cause the library preparation system to perform a corrective action based on the characteristics of the reagent. In some implementations, the corrective action may be wiping a tip coupled to a contact dispenser, for example when the processor 224 detects the presence of reagent adhering to the inside or outside of a tip. In some implementations, the corrective action may be to remove a tip coupled to the contact dispenser, for example when the processor 224 detects the presence of reagent adhering to the inside or outside of a tip. In some implementations, the corrective action may be to aspirate at least some of the reagent back into the tip, and dispense the reagent into the well.

Example 1. A modular system for preparing a library of samples for sequencing, the modular system comprising: an assay bay for performing an assay; a gantry system having a mover operatively coupled to the assay bay; and a camera attached to the gantry system and configured to capture images of the modular system, wherein the camera provides the images of the modular system to a computing device configured to analyze the images to determine a condition of the modular system.

Example 2. The system of example 1, wherein the camera is attached to the mover of the gantry system.

Example 3. The system of example 1 or 2, wherein the condition is based on a presence of a liquid inside a tip of a contact dispenser.

Example 4. The system of any one of the preceding examples, wherein the condition is based on a liquid adhering to the outside of a tip of a contact dispenser.

Example 5. The system of any one of the preceding examples, wherein the condition is based on a volume of a liquid in a tip of a contact dispenser being below a threshold volume.

Example 6. The system of any one of the preceding examples, wherein the condition is based on a volume of liquid in a well being below a threshold volume.

Example 7. The system of any one of the preceding examples wherein the condition is based on a contact dispenser not having a tip coupled to the contact dispenser.

Example 8. The system of any one of the preceding examples, wherein the condition is based on a tip being incorrectly coupled to a contact dispenser.

Example 9. A method for performing quality control in a library preparation system, the method comprising: obtaining, at one or more processors, an image of one or more components of a library preparation system; analyzing, by the one or more processors, the image to determine a condition of the one or more components; verifying, by the one or more processors, a presence, location, or alignment of the one or more components based on the condition; and causing, by the one or more processors, the library preparation system to perform a corrective action based on the condition of the one or more components.

Example 10. The method of example 9, wherein verifying the presence of the one or more components includes: analyzing, by the one or more processors, an image to identify a contact dispenser; analyzing, by the one or more processors, a portion of the image to identify a tip; and verifying, by the one or more processors, the presence of the tip in response to determining that the tip is coupled to the contact dispenser.

Example 11. The method of example 9 or example 10, wherein verifying the presence of the one or more components includes analyzing, by the one or more processors, an image to identify a contact dispenser; and analyzing, by the one or more processors, the image to determine that a tip has been removed from the contact dispenser.

Example 12. The method of any one of examples 9-11, wherein verifying the alignment of the one or more components includes: analyzing, by the one or more processors, the image to determine that each tip of a plurality of tips is vertically aligned.

Example 13. The method of any one of examples 9-12, wherein verifying the alignment of the one or more components includes: analyzing, by the one or more processors, an image to identify a plurality of contact dispensers; analyzing, by the one or more processors, the image to identify a plurality of tips coupled to the plurality of contact dispensers; and analyzing, by the one or more processors, the image to determine that each tip of the plurality of tips is in an upright position.

Example 14. The method of any one of examples 9-13, wherein causing the library preparation system to perform the corrective action includes: transmitting a control signal to the library preparation system to cause the library preparation system to remove a tip from the contact dispenser.

Example 15. The method of any one of examples 9-14, wherein causing the library preparation system to perform the corrective action further includes: transmitting a control signal to the library preparation system to cause the library preparation system to recouple the tip to the contact dispenser.

Example 16. The method of any one of examples 9-15, wherein verifying the presence of the component includes: analyzing, by the one or more processors, the image to identify a gripper; analyzing, by the one or more processors, the image to determine a plate is being held by a gripper; and verifying, by the one or more processors, that the plate is properly being held by the gripper based on the analysis.

Example 17. A computing device for performing quality control in a library preparation system, the computing device comprising: one or more processors; and a non-transitory computer-readable memory storing instruction thereon that, when executed by the one or more processors, cause the computing device to: obtain an image of one or more components of a library preparation system; analyze the image to determine a condition of the one or more components; verify a presence, location, or alignment of the one or more components based on the condition; and cause the library preparation system to perform a corrective action based on the condition of the one or more components.

Example 18. The computing device of example 17, wherein to verify the presence of the one or more components, the instructions cause the computing device to: analyze an image to identify a contact dispenser; analyze a portion of the image to identify a tip; and verify the presence of the tip in response to determining that the tip is coupled to the contact dispenser.

Example 19. The computing device of example 17 or 18, wherein to verify the presence of the one or more components, the instructions cause the computing device to: analyze an image to identify a contact dispenser; and analyze the image to determine that a tip has been removed from the contact dispenser.

Example 20. The computing device of any one of examples 17-19, wherein to verify the alignment of the one or more components, the instructions cause the computing device to: analyze the image to determine that each tip of a plurality of tips is vertically aligned.

Example 21. The computing device of any one of examples 17-20, wherein to verify the alignment of the one or more components, the instructions cause the computing device to: analyze an image to identify a plurality of contact dispensers; analyze the image to identify a plurality of tips coupled to the plurality of contact dispensers; and analyze the image to determine that each tip of the plurality of tips is in an upright position.

Example 22. The computing device of any one of examples 17-21, wherein to cause the library preparation system to perform the corrective action, the instructions cause the computing device to: transmit a control signal to the library preparation system to cause the library preparation system to remove a tip from the contact dispenser.

Example 23. The computing device of any one of examples 17-22, to cause the library preparation system to perform the corrective action, the instructions cause the computing device to: transmit a control signal to the library preparation system to cause the library preparation system to recouple the tip to the contact dispenser.

Example 24. The computing device of any one of examples 17-23, wherein to verify the presence of the component, the instructions cause the computing device to: analyze the image to identify a gripper; analyze the image to determine a plate is being held by a gripper; and verify that the plate is properly being held by the gripper based on the analysis.

Example 25. A non-transitory computer-readable memory storing instructions thereon that, when executed by one or more processors, cause the one or more processors to: obtain an image of one or more components of a library preparation system; analyze the image to determine a condition of the one or more components; verify a presence, location, or alignment of the one or more components based on the condition; and cause the library preparation system to perform a corrective action based on the condition of the one or more components.

Example 26. The computer-readable memory of example 25, wherein to verify the presence of the one or more components, the instructions cause the one or more processors to: analyze an image to identify a contact dispenser; analyze a portion of the image to identify a tip; and verify the presence of the tip in response to determining that the tip is coupled to the contact dispenser.

Example 27. The computer-readable memory of example 25 or 26, wherein to verify the presence of the one or more components, the instructions cause the one or more processors to: analyze an image to identify a contact dispenser; and analyze the image to determine that a tip has been removed from the contact dispenser.

Example 28. The computer-readable memory of any one of examples 25-27, wherein to verify the alignment of the one or more components, the instructions cause the one or more processors to: analyze the image to determine that each tip of a plurality of tips is vertically aligned.

Example 29. A method for performing quality control in a library preparation system, the method comprising: obtaining, at one or more processors, an image depicting a presence of a reagent in a library preparation system; analyzing, by the one or more processors, the image to detect the presence of the reagent and one or more characteristics of the reagent; and at least one of: verifying, by the one or more processors, that a threshold amount of the reagent has been dispensed from a component of the library preparation system; verifying, by the one or more processors, that the reagent is of sufficient quality based on the one or more characteristics; or causing, by the one or more processors, the library preparation system to perform a corrective action based on the one or more characteristics of the reagent.

Example 30. The method of example 29, wherein analyzing the image to detect the one or more characteristics of the reagent includes: analyzing, by the one or more processors, the image to identify a tip; and analyzing, by the one or more processors, the image to identify a liquid level of the reagent in the tip, wherein the liquid level indicates a volume of the reagent in the tip.

Example 31. The method of example 29 or 30, wherein verifying that the reagent is of sufficient quality includes: analyzing, by the one or more processors, the image to identify the presence of the reagent in a well; analyzing, by the one or more processors, the image to identify a color of the reagent; and determining, by the one or more processors, a quality of the reagent based on the color of the reagent.

Example 32. The method of any one of examples 29 to 31, wherein verifying that the threshold amount of reagent has been dispensed from the component of the library preparation system includes: analyzing, by the one or more processors, the image to identify a tip coupled to a contact dispenser; analyzing, by the one or more processors, the image to determine that the reagent has been completely removed from the tip based on a color of the reagent and a color within the tip.

Example 33. The method of any one of examples 29 to 32, wherein causing the library preparation system to perform the corrective action includes: transmitting, by the one or more processors, a control signal to the library preparation system to cause a tip to be removed from a contact dispenser.

Example 34. The method of any one of examples 29 to 33, wherein causing the library preparation system to perform the corrective action includes: transmitting, by the one or more processors, a first control signal to the library preparation system to cause a contact dispenser to dispense the reagent into a well; and in response to determining that at least some of the reagent adhered to the outside of a tip of the contact dispenser: transmitting, by the one or more processors, a second control signal to the library preparation system to cause the contact dispenser to aspirate the at least some reagent back into the contact dispenser; and transmitting, by the one or more processors, a third control signal to the library preparation system to cause the contact dispenser to dispense the at least some reagent into the well.

Example 35. The method of any one of examples 29 to 34, wherein causing the library preparation system to perform the corrective action includes: transmitting, by the one or more processors, a control signal to the library preparation system to cause the library preparation system to wipe a tip coupled to a contact dispenser with an absorbent material.

Example 36. A computing device for performing quality control in a library preparation system, the computing device comprising: one or more processors; and a non-transitory computer-readable memory storing instruction thereon that, when executed by the one or more processors, cause the computing device to: obtain an image depicting a presence of a reagent in a library preparation system; analyze the image to detect the presence of the reagent and one or more characteristics of the reagent; and at least one of: verify that a threshold amount of the reagent has been dispensed from a component of the library preparation system; verify that the reagent is of sufficient quality based on the one or more characteristics; or cause the library preparation system to perform a corrective action based on the one or more characteristics of the reagent.

Example 37. The computing device of example 36, wherein to analyze the image to detect the one or more characteristics of the reagent, the instructions cause the computing device to: analyze the image to identify a tip; and analyze the image to identify a liquid level of the reagent in the tip, wherein the liquid level indicates a volume of the reagent in the tip.

Example 38. The computing device of example 36 or example 37, wherein to verify that the reagent is of sufficient quality, the instructions cause the computing device to: analyze the image to identify the presence of the reagent in a well; analyze the image to identify a color of the reagent; and determine a quality of the reagent based on the color of the reagent.

Example 39. The computing device of any one of examples 36 to 38, wherein to verify that the threshold amount of reagent has been dispensed from the component of the library preparation system, the instructions cause the computing device to: analyze the image to identify a tip coupled to a contact dispenser; analyze the image to determine that the reagent has been completely removed from the tip based on a color of the reagent and a color within the tip.

Example 40. The computing device of any one of examples 36 to 39, wherein to cause the library preparation system to perform the corrective action, the instructions cause the computing device to: transmit a control signal to the library preparation system to cause a tip to be removed from a contact dispenser.

Example 41. The computing device of any one of examples 36 to 40, wherein to cause the library preparation system to perform the corrective action, the instructions cause the computing device to: transmit a first control signal to the library preparation system to cause a contact dispenser to dispense the reagent into a well; and in response to determining that at least some of the reagent adhered to the outside of a tip of the contact dispenser: transmit a second control signal to the library preparation system to cause the contact dispenser to aspirate the at least some reagent back into the contact dispenser; and transmit a third control signal to the library preparation system to cause the contact dispenser to dispense the at least some reagent into the well.

Example 42. The computing device of any one of examples 36 to 41, wherein to cause the library preparation system to perform the corrective action, the instructions cause the computing device to: transmit a control signal to the library preparation system to cause the library preparation system to wipe a tip coupled to a contact dispenser with an absorbent material.

Example 43. A non-transitory computer-readable memory storing instruction thereon that, when executed by one or more processors, cause the one or more processors to: obtain an image depicting a presence of a reagent in a library preparation system; analyze the image to detect the presence of the reagent and one or more characteristics of the reagent; and at least one of: verify that a threshold amount of the reagent has been dispensed from a component of the library preparation system; verify that the reagent is of sufficient quality based on the one or more characteristics; or cause the library preparation system to perform a corrective action based on the one or more characteristics of the reagent.

Example 44. The computer-readable memory of example 43, wherein to analyze the image to detect the one or more characteristics of the reagent, the instructions cause the computing device to: analyze the image to identify a tip; and analyze the image to identify a liquid level of the reagent in the tip, wherein the liquid level indicates a volume of the reagent in the tip.

Example 45. The computer-readable memory of example 43 or example 44, wherein to verify that the reagent is of sufficient quality, the instructions cause the computing device to: analyze the image to identify the presence of the reagent in a well; analyze the image to identify a color of the reagent; and determine a quality of the reagent based on the color of the reagent.

Example 46. The computer-readable memory of any one of examples 43 to 45, wherein to verify that the threshold amount of reagent has been dispensed from the component of the library preparation system, the instructions cause the computing device to: analyze the image to identify a tip coupled to a contact dispenser; analyze the image to determine that the reagent has been completely removed from the tip based on a color of the reagent and a color within the tip.

Example 47. The computer-readable memory of any one of examples 43 to 46, wherein to cause the library preparation system to perform the corrective action, the instructions cause the computing device to: transmit a control signal to the library preparation system to cause a tip to be removed from a contact dispenser.

Example 48. The computer-readable memory of any one of examples 43 to 47, wherein to cause the library preparation system to perform the corrective action, the instructions cause the computing device to: transmit a first control signal to the library preparation system to cause a contact dispenser to dispense the reagent into a well; and in response to determining that at least some of the reagent adhered to the outside of a tip of the contact dispenser: transmit a second control signal to the library preparation system to cause the contact dispenser to aspirate the at least some reagent back into the contact dispenser; and transmit a third control signal to the library preparation system to cause the contact dispenser to dispense the at least some reagent into the well.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,“ having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In one example, these terms include situation where there is no variation—0%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

What is claimed is:

1. A method for performing quality control in a library preparation system, the method comprising:
obtaining, at one or more processors, an image of one or more components of a library preparation system;
analyzing, by the one or more processors, the image to determine a condition of the one or more components;
verifying, by the one or more processors, a presence, location, or alignment of the one or more components based on the condition; and
causing, by the one or more processors, the library preparation system to perform a corrective action based on the condition of the one or more components.

2. The method of claim 1, wherein verifying the presence of the one or more components includes:
analyzing, by the one or more processors, an image to identify a contact dispenser;
analyzing, by the one or more processors, a portion of the image to identify a tip; and
verifying, by the one or more processors, the presence of the tip in response to determining that the tip is coupled to the contact dispenser.

3. The method of claim 1, wherein verifying the presence of the one or more components includes analyzing, by the one or more processors, an image to identify a contact dispenser;
and analyzing, by the one or more processors, the image to determine that a tip has been removed from the contact dispenser.

4. The method of claim 1, wherein verifying the alignment of the one or more components includes:
analyzing, by the one or more processors, the image to determine that each tip of a plurality of tips is vertically aligned.

5. The method of claim 1, wherein verifying the alignment of the one or more components includes:
analyzing, by the one or more processors, an image to identify a plurality of contact dispensers;
analyzing, by the one or more processors, the image to identify a plurality of tips coupled to the plurality of contact dispensers; and
analyzing, by the one or more processors, the image to determine that each tip of the plurality of tips is in an upright position.

6. The method of claim 1, wherein causing the library preparation system to perform the corrective action includes:
transmitting a control signal to the library preparation system to cause the library preparation system to remove a tip from a contact dispenser.

7. The method of claim 6, wherein causing the library preparation system to perform the corrective action further includes:
transmitting a control signal to the library preparation system to cause the library preparation system to recouple the tip to the contact dispenser.

8. The method of claim 1, wherein verifying the presence of the component includes:
analyzing, by the one or more processors, the image to identify a gripper;
analyzing, by the one or more processors, the image to determine a plate is being held by a gripper; and
verifying, by the one or more processors, that the plate is properly being held by the gripper based on the analysis.

9. A computing device for performing quality control in a library preparation system, the computing device comprising:
one or more processors; and
a non-transitory computer-readable memory storing instruction thereon that, when executed by the one or more processors, cause the computing device to:
obtain an image of one or more components of a library preparation system;
analyze the image to determine a condition of the one or more components;
verify a presence, location, or alignment of the one or more components based on the condition; and
cause the library preparation system to perform a corrective action based on the condition of the one or more components.

10. The computing device of claim 9, wherein to verify the presence of the one or more components, the instructions cause the computing device to:
analyze an image to identify a contact dispenser;
analyze a portion of the image to identify a tip; and
verify the presence of the tip in response to determining that the tip is coupled to the contact dispenser.

11. The computing device of claim 9, wherein to verify the presence of the one or more components, the instructions cause the computing device to:
analyze an image to identify a contact dispenser; and
analyze the image to determine that a tip has been removed from the contact dispenser.

12. The computing device of claim 9, wherein to verify the alignment of the one or more components, the instructions cause the computing device to:
analyze the image to determine that each tip of a plurality of tips is vertically aligned.

13. The computing device of claim 9, wherein to verify the alignment of the one or more components, the instructions cause the computing device to:
analyze an image to identify a plurality of contact dispensers;
analyze the image to identify a plurality of tips coupled to the plurality of contact dispensers; and
analyze the image to determine that each tip of the plurality of tips is in an upright position.

14. The computing device of claim 9, wherein to cause the library preparation system to perform the corrective action, the instructions cause the computing device to:
transmit a control signal to the library preparation system to cause the library preparation system to remove a tip from a contact dispenser.

15. The computing device of claim 14, wherein to cause the library preparation system to perform the corrective action, the instructions cause the computing device to:
transmit a control signal to the library preparation system to cause the library preparation system to recouple the tip to the contact dispenser.

16. The computing device of claim 9, wherein to verify the presence of the component, the instructions cause the computing device to:
analyze the image to identify a gripper;
analyze the image to determine a plate is being held by a gripper; and
verify that the plate is properly being held by the gripper based on the analysis.

17. A non-transitory computer-readable memory storing instructions thereon that, when executed by one or more processors, cause the one or more processors to:
obtain an image of one or more components of a library preparation system;
analyze the image to determine a condition of the one or more components;
verify a presence, location, or alignment of the one or more components based on the condition; and
cause the library preparation system to perform a corrective action based on the condition of the one or more components.

18. The computer-readable memory of claim 17, wherein to verify the presence of the one or more components, the instructions cause the one or more processors to:
analyze an image to identify a contact dispenser;
analyze a portion of the image to identify a tip; and
verify the presence of the tip in response to determining that the tip is coupled to the contact dispenser.

19. The computer-readable memory of claim 17, wherein to verify the presence of the one or more components, the instructions cause the one or more processors to:
analyze an image to identify a contact dispenser; and
analyze the image to determine that a tip has been removed from the contact dispenser.

20. The computer-readable memory of claim 17, wherein to verify the alignment of the one or more components, the instructions cause the one or more processors to:
analyze the image to determine that each tip of a plurality of tips is vertically aligned.
